(19) United States
(12) Patent Application Publication
(10) Pub. No.: US 2010/0325553 A1
(43) Pub. Date: Dec. 23, 2010

(54) NETWORK OF USER-AWARE MULTIPLE-PROTOCOL INTERNET BROWSERS

(75) Inventor: Eyal Levy, Tel Aviv (IL)

Correspondence Address: Eyal Levy, Rekanati 9, Tel Aviv, 69494, omitted

(73) Assignee: Eyal Levy, Tel Aviv (IL)

(21) Appl. No.: 12/489,664

(22) Filed: Jun. 23, 2009

(51) Int. Cl. G06F 3/01

(52) U.S. Cl. 715/738

(57) ABSTRACT

A method for Internet browsing where a subscriber/browser navigates to a new Internet (IPv4) address and multiple protocol/network data is gathered relative to the Internet location. The method includes subscribing by browsers to a proprietary Website, providing a client software program to each of the browser/subscribers, navigating by a browser to a new Internet IP-address (location), sending a notification to a main server of the proprietary website and registering by the server of the browser's new location. The method also includes sending back the location data to the browser-installed client software program, notifying all other browsers at the same location by the server of a newly arriving browser, notifying the newly arriving browser that others are already there, initiating communication between the first and newly arriving subscriber/browsers and graphically displaying all the data gathered.

### FIELD OF THE INVENTION

The present invention relates generally to Internet browsing, and more particularly, to a method for browsing and exploring an Internet Protocol (IP) address and for determining whether other network users are exploring the same IP address.

### BACKGROUND OF THE INVENTION

The Internet, as it is known today, is a global network of inter-connected computer systems. The Internet has many uses. The most publicly known and used is the www (World Wide Web), which basically consists of Web servers holding Web sites (which are server-software applications listening on port 80) and what is commonly known as Internet browsers, which are client softwares used to browse the Internet.

Today's all Internet browsers are browsers which only query the network's servers at port 80 (the HTTP port), and receive a reply in the form of a “Web page” (data from the Web server is written and displayed graphically through the client software, or Internet browser).

But there is much more to the Internet than this. Many more known networks operate simultaneously on the Internet on different ports (IRC, NEWS, FTP etc), and furthermore each IP address contains much more data to see and understand. Today, there are no known Internet browsers that provide the public the complete picture and understanding of what real Internet browsing could look like. Instead, today's browsers browse one port only (port 80), and the public only sees the Internet as a network of Web servers, while truly, the Internet holds many more networks and data.

In U.S. Pat. Applic. No. 20080250026, Linden, et al, describe a System for Recommendations Based on Cross-Site Browsing Activities of Users. The system provides recommendations of Web sites, Web pages, and/or products to a user based on web pages viewed during a current browsing session. In one embodiment, a browser plug-in or other client program monitors and reports information regarding browsing activities of users across multiple web sites. The resulting cross-site browse histories of the users are analyzed on an aggregated basis to detect behavior-based associations between particular sites, pages and/or products. The detected associations are in turn used to provide personalized recommendations to users. The associations and recommendations may also be based on an automated analysis of the content of the web pages represented in the users' browse histories.

In U.S. Pat. Applic. No. 20080030496, Lee, et al, teach an On-Line Interaction System. An avatar display system monitors the activities or status of different members on a network site. Avatars representing the different members are displayed in conjunction with an on-line application according to the different identified member activities or status. Different avatar display techniques and filtering schemes are used to both promote and improve interactions between different members of the on-line application or Website.

In U.S. Pat. Applic. No. 20050198162, Bauer, et al, teach a Method and System of Collaborative Browsing. A dynamic collaborative-browsing system enables client programs connected to a computer network to join and leave groups or sessions, to collaboratively browse together as a session, to communicate with other client programs in the session. Each client program in the session may act as a session leader, or may just follow a session leader as it browses network sites of the computer network. The system includes client programs, typically executing on client computers and server software, typically executing on one or more main servers. Network servers, such as Web servers, host a number of network sites each having a location or uniform resource locator (URL). The main server groups into server-defined cells.

One or more client programs interact with the server software to cause the server to create a session, to cause the client program to connect to a network site, to notify the server software of the network site's location or URL, and to notify other client programs in the session of the network site's location or URL so that other client programs in the session become connected to the same network site. The server software facilitates the formation of client programs into sessions and allows the client programs to communicate, to connect to and view a same network site, and to perform other collaborative activities. The server software also groups sessions currently connected to network sites in a same cell, and notifies each session and the client programs of the sessions of all of the other sessions and client programs in the same cell. The server software also facilitates communication between the sessions and client programs connected to network sites in the same cell.

### SUMMARY OF THE INVENTION

Accordingly, it is a principal object of the present invention to provide a means for browsing and exploring an Internet IP address for multiple protocols servers, such as HTTP/IRC/NNTP servers, and for IP-address data, including Internet service provider and country.

It is another principal object of the present invention to provide a means for viewing whether other network users are exploring the same IP address.

It is one other principal object of the present invention to provide a means for two or more users to browse the same Internet address, wherein they are enabled to communicate with each other.

A method for Internet browsing where a subscriber/browser navigates to a new Internet (IPv4) address and multiple protocol/network data is gathered relative to the Internet location. The method includes subscribing by browsers to a proprietary Website, providing a client software program to each of the browser/subscribers, navigating by a browser to a new Internet IP-address (location), sending a notification to a main server of the proprietary website and registering by the server of the browser's new location. The method also includes sending back the location data to the browser-installed client software program, notifying all other browsers at the same location by the server of a newly arriving browser, notifying the newly arriving browser that others are already there, initiating communication between the first and newly arriving subscriber/browsers and graphically displaying all the data gathered.

The present invention provides a new way to explore the Internet. It is a “manned Internet probe” or “manned Internet ship.” It provides the visual look and feel of being inside an Internet spaceprobe, travelling at the speed of light through the Internet, which is displayed on the screen by a variety of real-time data panels and visualizations.

The graphical user interface (GUI) represents a cockpit view, having, for example four panels around a main screen: Navigation, Communication, Radar and Visual as quadrants of a “spaceship's” main screen/window.

The ship is always located (“docked”) at one IPv4 or IPv6 address. It intends to gather all known real-time data on an IP address, including general Internet data: Websites present, IRC networks, NTTP servers, other servers, mail pop, etc., country and time zone (IP/Geolocation DB table), ISP, connection type and internal “probes-network” data, such as: other “spaceships/probes” at the same location, subscriber rooms, other ship/probe communication requests. These are displayed on the ship's respective panels.

A subscriber/browser opens his room by himself, providing the room “space” was not taken before by another browser/subscriber. The rooms created at one IP address could be organized in the form of an underground construction, having underground floors, “Level A”, “Level B,” etc. I.e., if no rooms were open before at IP “xxx.xxx.xxx.xxx” (pr IPv6 address), a browser/subscriber may open his own room at “level A”. There could be only one room per level, for any number of levels (decided by the networks's owners). In the preceding example, if a browser/subscriber has opened a room in Level A at a specific location, the next browser/subscriber wishing to open a room at this (IP) location could only choose the “Level B” room or lower.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a schematic illustration of a system block diagram, constructed in accordance with the principles of the present invention;

FIG. 2 is an exemplary schematic illustration of a main user interface, constructed in accordance with the principles of the present invention;

FIG. 3 is a schematic illustration of an exemplary Web server panel on the graphical user interface (GUI), constructed in accordance with the principles of the present invention;

FIG. 4 is a schematic illustration of an exemplary communication server panel on the graphical user interface (GUI), constructed in accordance with the principles of the present invention; and

FIG. 5 is a schematic illustration of an exemplary favorites panel on the graphical user interface (GUI), constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

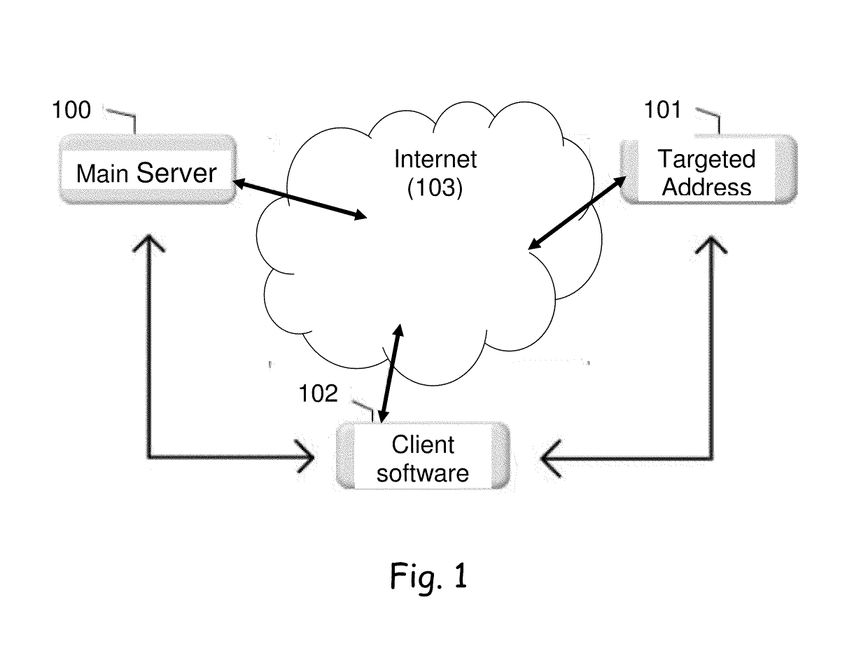

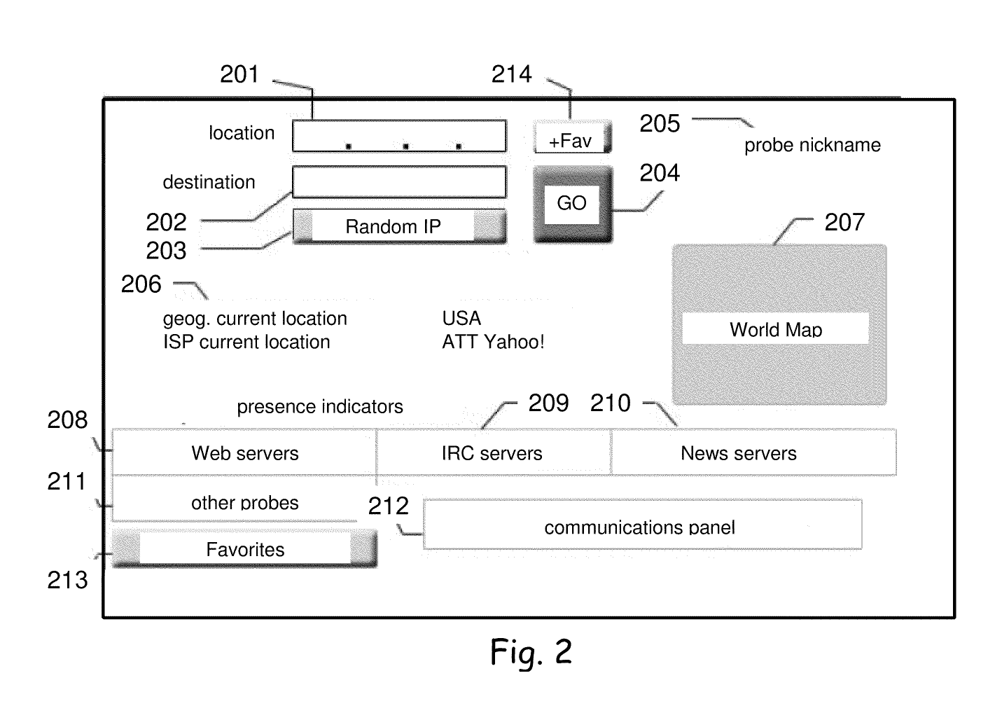

FIG. 1 is a schematic illustration of a system block diagram, constructed in accordance with the principles of the present invention. The browser 102 receives and sends all communication data through the main server 100. Browser (or probe) is an executable-code client software program 102, with a graphical user interface (GUI), with reference to the schematic example described below in FIG. 2. Upon execution, it connects over the Internet 103 to the network's main server 100. Main server 100 is in charge of all synchronization/communication between the browsers. Server 100 registers a new browser/probe entry (having a unique ID—nickname) to the network, and registers the incoming Internet Protocol (IP) address of browser 102 as the browser's origin IP-address.

Server 100 then extracts the matching country and Internet service provider (ISP) from the origin IP-address from a local-cache IP-address-ISP-country table, and reports these back to browser 102, which in turn displays the data to the user through the exemplary GUI of FIG. 2, described below. The term “location” is defined herein as referring to an Internet IP-address, and when a browser explores a location, the browser/probe is considered “present” at the location.

Browser 102 is able to navigate to and explore any IP targeted address 101 by entering an IP address (for example 194.95.120.20) or DNS address (for example www.yahoo.com). When a browser 102 navigates to a new Internet address 101, it sends notification to the main server 100 and the server registers the browser's new location and sends back the IP-address data (corresponding ISP, country of new IP location). In the case of other browsers currently exploring the same IP address, the server 100 notifies all other browsers at location 101 of a new browser (identified by nickname) at location. In this case the server 100 also informs the arriving browser 102 that other browsers are present at this location.

User/subscribers browsing the network also have the option to “open” their own room anywhere on the Internet (on any IPv4 address). In these rooms the user opening the room can post articles, pictures or videos, decide on access control, conduct private and group chats, and optionally build any application, such as a poker room, online store, etc. Such subscriber rooms may be regarded as initially belonging to the user who opened the room, and may be bought or sold between subscribers.

FIG. 2 is an exemplary schematic illustration of a main user interface, constructed in accordance with the principles of the present invention. Targeted IP address of FIG. 1 is entered to the destination field 202 and the “GO button 204 is pressed. By pressing the “Random IP” button 203, a randomized IP address will be filled in at destination field 202, enabling the user to navigate the browser to this generated random address by pressing “GO” button 204. The origin-IP address is displayed in location field 201, and all other data is displayed in the data field 206, which is also represented on world map 207. That other browsers are present at the location is shown through the other probes indicator 211. New browser/probe entries are registered with unique ID's, i.e. nicknames 205.

When browser 102 of FIG. 1 navigates to a new Internet address 101, it also sends TCPIP connection requests directly to targeted address 101, checking for and communicating with multi-protocol application servers, such as Web 208, IRC 209 and news 210. If the connection requests are successful, browser 102 alerts the user of the presence of these servers through the GUI in the corresponding fields 208, 209 and 210.

By pressing the “+Fav” button 214, the user may add the current location to his favorites list 213. The user is also prompted to add a description to the entry that has been created. “Other probes” indicator 211 in the GUI issues alerts for other browsers from the network present at current location 206. In case a browser receives a broadcast message or a communication request while its communication panel is closed, the indicator of communication panel 212 turns on. By clicking it, communication panel 212 opens.

If there is a present IRC/news (NNTP) server, clicking IRC indicator 209 or news server indicator 210 opens an IRC server panel or a news server panel respectively. The IRC server panel is an internal, very basic IRC client with a direct TCPIP connection to the IRC server (internal client's features: prompt for username, list channels, enter channel, list channel users, open new channel, send/receive-both channel and private messages). The news server panel is an internal basic news client with a direct TCPIP connection to the news server (internal client's features: list news groups, enter group, count/list/read/post messages).

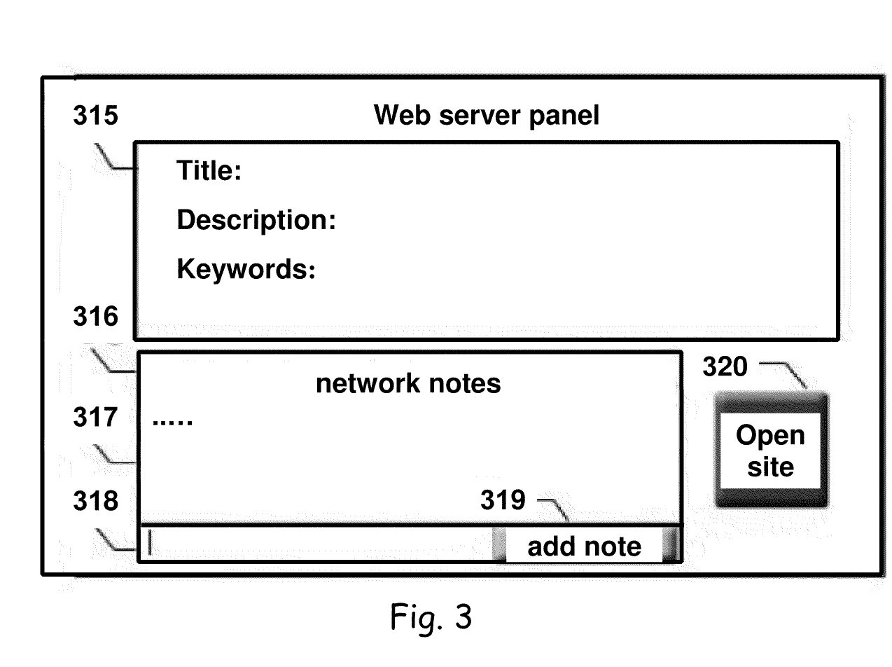

FIG. 3 is a schematic illustration of an exemplary Web server panel on the graphical user interface (GUI), constructed in accordance with the principles of the present invention. If there is a present Web server, by clicking Web server indicator 208 of FIG. 2, a Web server panel opens, and the browser, using its direct TCPIP connection to the Web server, extracts and displays the Website's Metadata (title, description and keywords) in the data field 315. The browser also queries the main server for any “network notes” 317 written in the “network notes” field 316. Any notes previously written about this site by all network users are shown, enabling the user to add a network note in the designated field 318 and the “add note” button 319, thereby informing the main server of this new network note at the present location. The main server may store the “networks notes” data in a local or remote database table.

The Web server panel also has an “open site” button 320, which enables the user to browse the Website through his default (HTTP) Web browser.

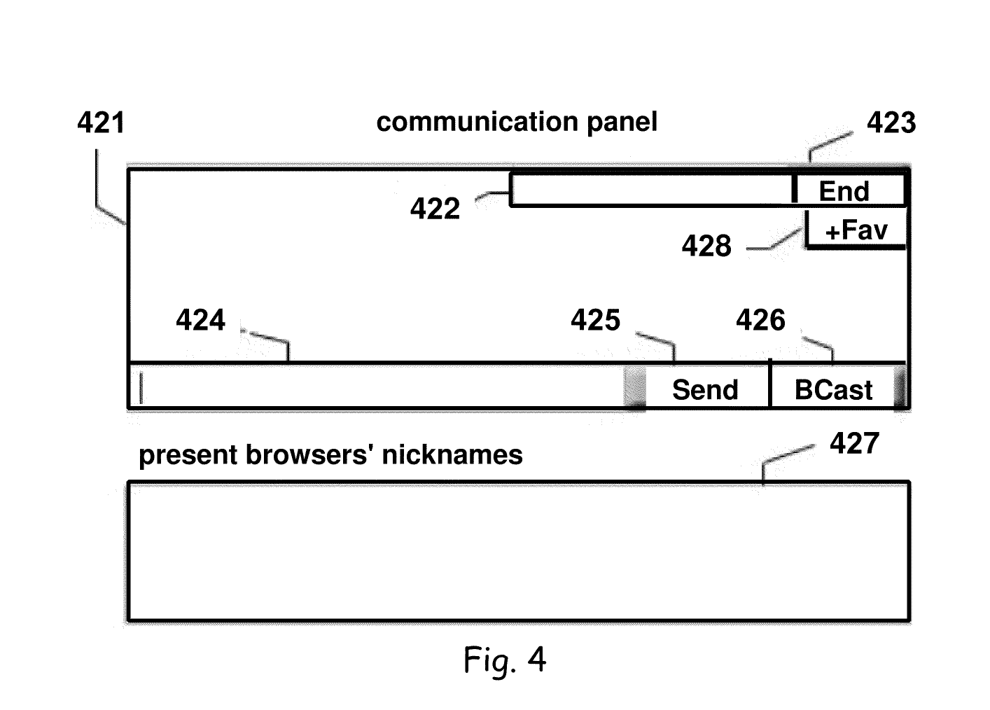

FIG. 4 is a schematic illustration of an exemplary communications panel on the graphical user interface (GUI), constructed in accordance with the principles of the present invention. The user is able to view the present browsers' nicknames list 427. By double-clicking on one nickname, a communication channel is opened—a one on one chat. The chat is displayed in the chat area 421, with the nickname of the communicating browser displayed above it in the nickname field 422. The user writes his messages in the input field 424, and sends a message by pressing the send button 425. The user is able to end communication by pressing the end button 423, and can add the other-end browser to his favorites list by pressing the communications panel “+Fav” button 428.

Broadcast is another communication option, enabling the user to send a message to all browsers at the current location, by writing the message in the input field 424 and pressing the broadcast button 426. All browsers in current location receive the message and sender's nickname (marked as broadcast) in their chat area 421.

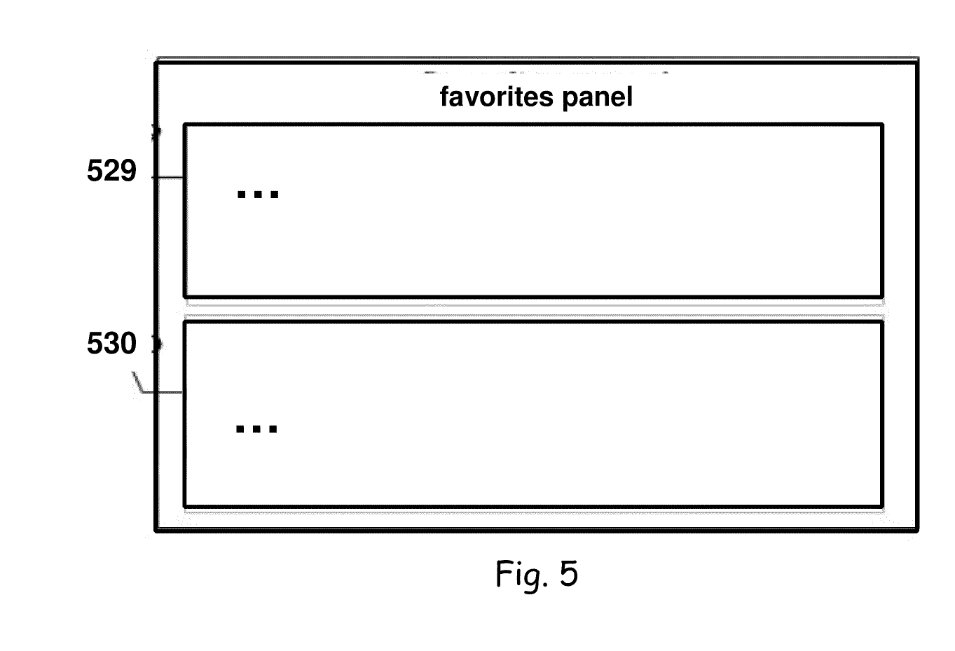

FIG. 5 is a schematic illustration of an exemplary favorites panel on the graphical user interface (GUI), constructed in accordance with the principles of the present invention. Browser's favorites lists are saved locally on the computer where the client software is installed. By clicking the Favorites button 213 on the main UI shown in FIG. 2, the favorites panel of FIG. 5 appears. The favorites panel is divided to two parts:

The upper field 529 shows the favorite browsers list; their nicks, whether they are online, and if so—by double clicking on the selected browser the communication panel (FIG. 4) opens with an open communication channel to the selected browser. The user is also able to delete browsers from his favorites list.

The lower field 30 shows the favorite IP-addresses list, with the description the user entered for it. Double-clicking on the address navigates the browser to the chosen location. The user is able to edit an address description and to remove a selected address from his favorites list.

This system offers a broader venue for exploring of the Internet, for it browses multi-protocol servers simultaneously (it may further browse for servers not noted in this document, such as: mail, FTP etc). Furthermore, the system enables viewing and communicating with other users currently browsing the same Internet address, providing a new means of an indexed communication application to the online community: a communication network based directly on the user's Web browsing preferences.

Having described the present invention with regard to certain specific embodiments thereof, it is to be understood that the description is not meant as a limitation, since further modifications will now suggest themselves to those skilled in the art, and it is intended to cover such modifications as fall within the scope of the Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A method for Internet browsing, wherein when a subscriber/browser navigates to a new Internet (IPv4) address, multiple protocol/network data is gathered by a proprietary Website relative to the Internet location, said method comprising:
subscribing by a plurality of browsers to a proprietary Website;
providing a client software program to each of said browser/subscribers;
navigating by a first browser to a new Internet IP-address (location);
sending a notification to a main server of said proprietary website;
registering by said server of said first browser's new location;
sending back said location data by said server to said browser-installed client software program;
notifying all others of said plurality of browsers at the same location by said server of a newly arriving browser;
notifying said newly arriving browser that others are already there;
initiating communication by one of said first and said newly arriving of said plurality of subscribers/browsers with the other of the two; and
graphically displaying all the data gathered.

2. The method of claim 1, wherein said graphical display has the look and feel of a spaceship's cockpit.

3. The method of claim 1, wherein the multiple protocol/network data relative to the Internet location comprises at least one of:
presence of Web servers:
presence of IRC gateways;
presence of News servers;
IP/Geo-location;
presence of other (manned) probes;
communication requests; and
presence of private rooms created by “probes-network” subscribers.

4. The method of claim 1, further comprising enabling said subscriber/browsers to establish their own “room” relative to any Internet browser Protocol (IP) address.

5. The method of claim 4, wherein said room is optionally at least one of a poker room, an online store and is used to do at least one of manage the chats, post articles, give ratings and make recommendations and comments.

6. The method of claim 1, wherein said client software program is downloaded to each of said plurality of browsers by said proprietary Website.

7. A system to enable browser/subscribers who have navigated to the same IP-address (location) to establish their own “room” relative to any Internet browser Protocol (IP) address, a room where they do at least one of manage the chats, post articles, give ratings and make recommendations and comments, said system comprising:
a Web server to receive and send all communication data to said browsers; and
an executable-code client software program with a graphical user interface (GUI), which, upon execution connects over the Internet to said server.
